(19) United States
(12) Patent Application Publication
(10) Pub. No.: US 2009/0004075 A1
(43) Pub. Date: Jan. 1, 2009

(54) Apparatus for mass production of carbon nanotubes using high-frequency heating furnace

(75) Inventors: Sang-Moon Chung, Siheung-si (KR); Heon Ham, Siheung-si (KR)

Correspondence Address: HOLLAND & HART, LLP, P.O BOX 8749, DENVER, CO, 80201, US

(73) Assignee: Viko System Co., Ltd., Gyeonggi-do (KR)

(21) Appl. No.: 11/890,285

(22) Filed: Aug. 2, 2007

(30) Foreign Application Priority Data
Jun. 26, 2007 (KR) 10-2007-006275

(51) Int. Cl. B01J 19/00

(52) U.S. Cl. 422/198

(57) ABSTRACT

The apparatus for mass production of carbon nanotubes uses a high-frequency furnace and a fluid flow process. A metallic catalyst and a reaction gas are supplied into a reaction chamber so that the catalyst and the decomposed carbonization gas are reacted in a vapor phase in the chamber to produce the nanotubes. After the reaction, the carbonization gas and the carbon nanotubes are transferred to a filter via a heat exchanger in which they are separated from each other. Then, the carbon nanotubes are collected in a collector, hydrocarbon of the reacted gas burns in air and is discharged to the outside, and inert gas, such as nitrogen and argon, is collected and supplied again to the chamber. The apparatus produces the nanotubes in mass quantities under atmospheric pressure, and requires no separate vacuum device, minimizing the scale and cost of the equipment.

### BACKGROUND OF THE INVENTION

1. Field of the Invention

The present invention relates to an apparatus for mass production of carbon nanotubes using a high-frequency induction furnace and a fluid flow process, and more particularly to an apparatus for mass production of carbon nanotubes, which heats the inside of a vertical tube type reaction chamber to a reaction-inducing temperature using a high-frequency heating furnace for continuous production of the carbon nanotubes.

2. Description of the Related Art

Carbon nanotubes have a diameter just of several tens of nanometers, an electric conductivity similar to that of copper, a thermal conductivity similar to that of diamond, which is the highest in the nature, a strength one hundred thousand times that of steel, and excellent tension and resistance to deformation. That is, the carbon nanotubes have properties required as a future new material, thus having a high applicability to all industrial fields.

The production technique of the carbon nanotubes is divided into an arc discharge method, a laser deposition method, an electric furnace method, a plasma method, etc., according to how to use energy for producing the carbon nanotubes, and into a vapor-phase synthesis method and a substrate synthesis method according to how to input a metallic catalyst.

In the plasma method that has been recently tried for mass production of carbon nanotubes, carbonization gas and a catalyst are brought into direct contact with a plasma heat source in a chamber at high temperature to produce carbon nanotubes. In the arc discharge method, graphite rods having different diameters are provided to a cathode and an anode and separated a predetermined distance from each other, followed by inducing arc discharge to produce carbon nanotubes. Such high heat-based synthesis methods produce carbon nanotubes having excellent crystallization, but also produce impurities, i.e., carbon flakes having the crystallization of the carbon nanotubes. Further, these methods suffer from difficulty in controlling the diameter of the carbon nanotubes. Moreover, since the heating based on combustibles does not allow reasonable operation, these methods cannot achieve reliable temperature and quality control.

Instead of the methods using a heat source at high temperature such as the plasma method and the arc discharge method, a fluid flow process using an electric furnace has been proposed. The fluid flow process based on the electric furnace is suitable for mass production, but is disadvantageous in that time for raising and lowering the temperature of a heater as a heat source is excessively long, and in that, once the shape of the electric furnace is determined, the size and shape of the reaction furnace cannot be changed.

### SUMMARY OF THE INVENTION

The present invention has been made in view of the above problems, and it is an object of the present invention to provide an apparatus for mass production of carbon nanotubes, which heats the inside of a reaction chamber using high-frequency induction heating that is applied to metal heating.

In accordance with one aspect of the present invention, the above and other objects of the present invention can be achieved by the provision of an apparatus for mass production of carbon nanotubes using a high-frequency heating furnace, comprising: a reaction chamber receiving a metallic catalyst and a reaction gas to synthesize carbon nanotubes through high-frequency induction heating; a high-frequency oscillator to supply a high frequency to the reaction chamber; a heat exchanger to pass the reacted gas and the carbon nanotubes synthesized in the reaction chamber; a filter to separate the carbon nanotubes from the reacted gas, both having passed through the heat exchanger; a collector to collect the carbon nanotubes having passed through the filter; a gas discharger to discharge hydrocarbon of the reacted gas, having passed through the filter, to the outside; and a gas circulator to receive inert gas out of the reacted gas, having passed through the filter, and to supply the inert gas again to the reaction chamber.

The high-frequency induction heating may be performed using a frequency in one frequency band selected from 50˜60 Hz, 100 Hz˜10 kHz, 10˜500 kHz, and 100˜500 kHz.

### BRIEF DESCRIPTION OF THE DRAWINGS

The above and other objects, features and advantages of the present invention will become apparent from the following description of exemplary embodiments given in conjunction with the accompanying drawings, in which:

FIGS. 1, 2a and 2b are views illustrating the principle of high-frequency induction heating of a high-frequency heating furnace, to which the present invention is applied; and

FIG. 3 is a schematic view of an apparatus for mass production of carbon nanotubes using a high-frequency heating furnace in accordance with the present invention.

### DETAILED DESCRIPTION OF THE INVENTION

Exemplary embodiments of the present invention will be described in detail with reference to the accompanying drawing hereinafter.

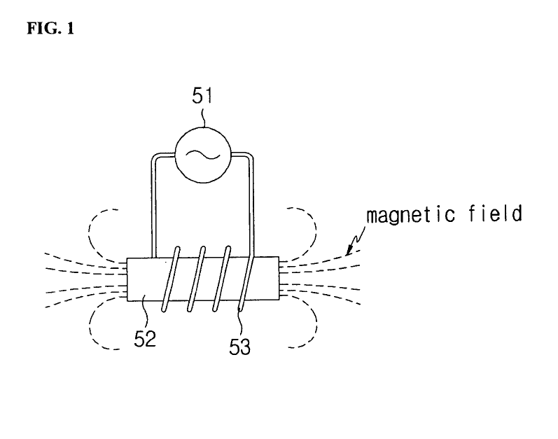

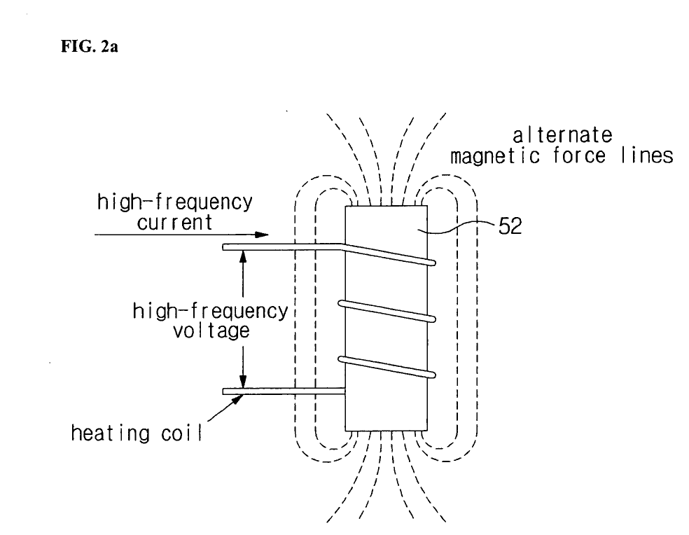

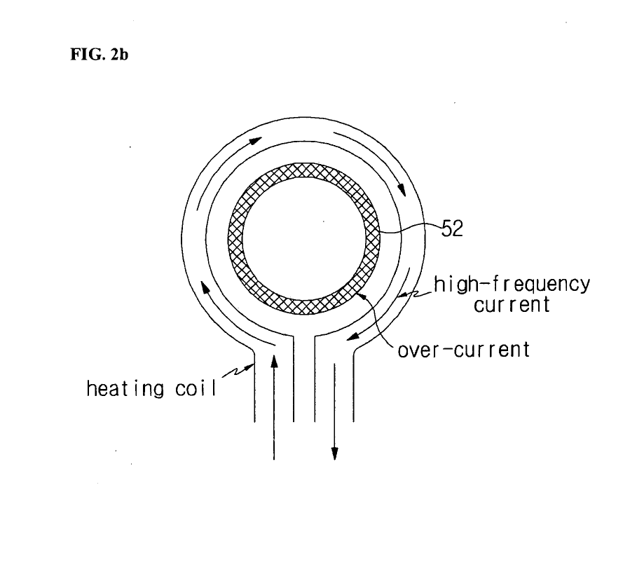

Now, the principle of induction heating will be described. In FIGS. 1, 2a, and 2b, a conductive workpiece 52 such as metal and the like is located in a coil 53, through which AC (high-frequency) flows to generate heat in the coil 53 by resistance of eddy current loss and Hysteresis loss (in the case of magnetic substances). That is, induction heating of the workpiece 52 (metal or other conductive materials) as a heating target by means of thermal energy generated in the coil is applied to the apparatus for mass production of carbon nanotubes.

According to an exemplary embodiment of the present invention, an apparatus for mass production of carbon nanotubes using a high-frequency heating furnace, comprises: a reaction chamber 1 that receives a metallic catalyst 7 and a reaction gas 13 to synthesize carbon nanotubes through high-frequency induction heating; a high-frequency oscillator 11 for supplying a high frequency to the reaction chamber 1; a heat exchanger 2 for passing the reacted gas and the carbon nanotubes synthesized in the reaction chamber 1; a filter 6 for separating the carbon nanotubes from the reacted gas, both having passed through the heat exchanger 2; a collector 3 for collecting the carbon nanotubes having passed through the filter 6; a gas discharger 4 for discharging hydrocarbon of the reacted gas, having passed through the filter 6, to the outside; and a gas circulator 5 for receiving inert gas out of the reacted gas, having passed through the filter 6, and for supplying the inert gas again to the reaction chamber 1. The high-frequency induction heating is performed at a frequency in one frequency band selected from 50˜60 Hz, 100 Hz˜10 kHz, 10˜500 kHz, and 100˜500 kHz.

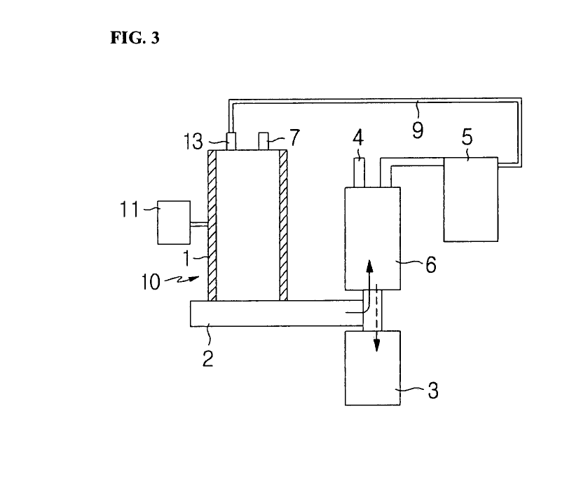

FIG. 3 illustrates an overall construction of the apparatus in accordance with the present invention.

Referring to FIG. 3, the catalyst and reaction gas are put into the reaction chamber 1 of the high-frequency heating furnace 10 through a catalyst inlet 7 and a reaction gas inlet 13. A metallic catalyst such as iron, nickel, etc. is selected as the catalyst 7 to be put into the reaction chamber 1, and, carbonization gas is used as the reaction gas. When a high frequency is supplied from the high-frequency oscillator 11 to the reaction chamber 1, the metallic catalyst and decomposed carbonization gas are reacted in a vapor phase inside the reaction chamber 1 to produce carbon nanotubes.

In high-frequency induction heating of the invention, induction heating of conductive metal is employed to heat the reaction chamber 1. The frequency used in the high-frequency induction heating is classified into a low frequency (usable frequency of 50˜60 Hz), a medium frequency (usable frequency of 100 Hz˜10 kHz), a high frequency (usable frequency of 10˜500 kHz), or a radio frequency (usable frequency of 100˜500 kHz). That is, a proper frequency can be selected in a wide range depending on purposes of use.

Frequency output is one of important factors in this invention. When the frequency output is determined, the scales of the reaction chamber (reaction furnace) and the overall apparatus are determined.

For reference, the following Table 1 shows kinds of frequency power, which are usable in high-frequency induction heating, and respective features thereof. Although these frequency powers have the same heating function, a proper frequency can be selected in consideration of capacity, installation cost, maintenance cost, and the like, with reference to the following Table 1.

The high-frequency heating furnaces are divided into various output types according to size of the apparatus. That is, there are a motor generator type (10˜600 kW), a vacuum tube type (2˜500 kW), a thyristor type (10˜2000 kW), and a transistor type (2˜300 kW). The respective type high-frequency furnaces are also divided into a low-frequency type (50˜60 Hz), a medium-frequency type (100 Hz˜10 kHz), a high-frequency type (10˜500 kHz), and the like, depending on frequency band. Accordingly, the high-frequency furnaces listed in Table 1 are divided according to the frequency band.

TABLE 1

| Frequency source | Moro generator type | Vacuum tube type | Thyristor type | Transistor type |
|---|---|---|---|---|
| Frequency | 1~10 kHz | 30~500 kHz | 500Hz~10 kHz | 1~200 kHz |
| Output | 10~600 kW | 2~500 kW | 10~2,000 kW | 2~300 kW |
| Frequency | Regular | Magnetic oscillation | Regular, variable | Regular |
| variation | | variable | | |
| Electric power | Magnetic voltage, | Positive voltage | DC voltage, | DC voltage, DC |
| adjustment | Regular voltage | | frequency | current |
| Converter | 70% | 60% | 92% | 92% |
| efficiency | | | | |
| Consumption | Bearing | vacuum tube | No | no |
| goods | | | | |
| Equipment area | Large | medium | Small | small |
| Time required to | Long | Short | Short | Short |
| repair | | | | |
| Parallel operation | Possible | Impossible | Impossible | Impossible |
| Cooling water | Large | Large | Small | Small |
| amount | | | | |
| Roaring sound | Yes | No | Yes | No |
| Depth of hardened | 3~15 mm | 0.5~5 mm | 3~15 mm | 0.5~5 mm |
| layer of article to | | | | |
| be quenched | | | | |
| Application | Heat treatment | Heat treatment | Heat treatment | Heat treatment |

Table 1 shows four kinds of frequency source. These frequency sources serve as a high-frequency heating furnace, which uses generated heat for heat treatment of metal. However, it should be noted that these frequency sources are provided only for illustrative purpose in synthesis of inventive nanotubes using the apparatus described above, and that the present invention is not limited to these frequency sources.

For reference, a general electric furnace is heated up to a temperature of approximately 1,100° C., but is substantially used at a temperature of 1,000° C. on the grounds of safety of equipment. Thus, it is substantially difficult to heat the electric furnace up to temperatures of 1,500˜2,000° C. In practice, a reaction process often requires heating at about 1,500° C. in respective reaction zones to induce a stable reaction. Therefore, it is difficult to adjust suitable temperature and reaction zone for the reaction with the electric furnace that has restricted reaction zones and temperature ranges.

However, the apparatus of this invention supplies a heat source that enables free control of the temperature for each reaction zone, and is convenient in adjusting the furnace temperature for each reaction zone using the high-frequency heating furnace. Further, the heating furnace (reaction chamber) provided in a high-frequency heating coil can be easily replaced with another chamber having a necessary size according to reaction conditions, and the shape and size of the reaction chamber (reaction furnace) can be freely modified so as to be suitable for the reaction process.

Particularly, according to the present invention, a high-temperature state at a specific reaction portion of the reaction chamber (reaction furnace) is freely selected and thus the reaction can be stably achieved.

To obtain a high temperature of approximately 1,500° C., the conventional plasma method can be proposed. Although the conventional plasma method can be applied to production of nanotubes, it has a drawback: since nanotubes are produced through direct contact with plasma, there is a difficulty in control of diameter, length and the like of the nanotubes.

According to the present invention, however, the apparatus using the high-frequency heating furnace can solve the problem in control of the diameter, length and the like of the nanotubes and can be constituted to a system for mass production of the nanotubes.

Next, the construction of the apparatus will be described with reference to FIG. 3.

Synthesized carbon nanotubes and carbonization gas used for synthesis of the carbon nanotubes in the reaction chamber pass through the heat exchanger 2 and are delivered to the filter 6. The filter 6 separates the carbon nanotubes from the reacted gas. That is, the carbon nanotubes are collected by the collector 3, and, hydrocarbon out of the reacted gas is burnt in air and discharged to the outside through the discharger 4. On the other hand, inert gases, such as nitrogen and argon, out of the reacted gas are collected, pass through the gas circulator 5, and are then supplied again along with the carbonization gas to the reaction chamber 1 in the reaction furnace via a circulation channel 9.

As apparent from the above description, according to the present invention, the apparatus for mass production of carbon nanotubes employs a high-frequency heating furnace 10 and a fluid flow process to allow stable supply of a metallic catalyst into a stable reaction chamber 1 so that the catalyst 7 continuously reacts with carbonization gas in the reaction chamber 1 to produce carbon nanotubes in mass quantities.

Further, the apparatus of the present invention allows easy adjustment of reaction temperature and easy modification of shape, installation and structure of the reaction chamber 1, and is advantageous in view of low installation costs, as compared with other equipment such as an electric furnace. Particularly, the apparatus of the present invention enables mass production of the nanotubes under atmospheric pressure, eliminating a need of a separate vacuum device and thus minimizing the scale and cost of equipment.

Further, according to the present invention, high-frequency induction heating is advantageous in that the reaction chamber 1 can be rapidly heated to a uniform temperature and, if required, only a specific zone of the reaction chamber 1 can be rapidly heated. Further, the heat-frequency induction heating used in this invention enables a decrease in process time via decrease in heating time, and individual control of temperature for respective zones in the reaction chamber 1, so that the apparatus can achieve excellent temperature control of the reaction chamber compared with any other devices.

In other words, when considering that one of important factors in synthesis of the carbon nanotubes is the temperature control, the apparatus of the invention facilitates precise control of temperature in a wide range with a heating coil to achieve easy adjustment of reaction temperature in the reaction chamber 1, and allows carbonization gas and a metallic catalyst to be reacted with each other in the reaction chamber 1 under stable temperature state and gas flow, thereby producing carbon nanotubes (MWCNT, DWCNT, and SWCNT) having various structures.

Further, the apparatus of the invention can be instantly operated and stopped, thus allowing prompt use when necessary.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. An apparatus for mass production of carbon nanotubes using a high-frequency heating furnace, comprising:
a reaction chamber receiving a metallic catalyst and a reaction gas to synthesize carbon nanotubes through high-frequency induction heating;
a high-frequency oscillator to supply a high frequency to the reaction chamber;
a heat exchanger to pass the reacted gas and the carbon nanotubes synthesized in the reaction chamber;
a filter to separate the carbon nanotubes from the reacted gas, both having passed through the heat exchanger;
a collector to collect the carbon nanotubes having passed through the filter; a gas discharger for discharging hydrocarbon of the reacted gas, having passed through the filter, to the outside; and
a gas circulator to receive inert gas out of the reacted gas, having passed through the filter, and to supply the inert gas again to the reaction chamber.

2. The apparatus according to claim 1, wherein the high-frequency induction heating is performed using a frequency in one frequency band selected from 50˜60 Hz, 100 Hz˜10 kHz, 10˜500 kHz, and 100˜500 kHz.

3. The apparatus according to claim 1, wherein the reaction gas comprises hydrocarbon, nitrogen, and argon.

4. The apparatus according to claim 1, wherein the catalyst comprises iron and nickel.
